(19) United States
(12) Patent Application Publication
(10) Pub. No.: US 2006/0242060 A1
(43) Pub. Date: Oct. 26, 2006

(54) System and method for the collection and management of firearm transactions and logs

(76) Inventors: Michael Boutin, Duluth, GA (US); Lester Andrews, Atlanta, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 11/403,376

(22) Filed: Apr. 12, 2006

Related U.S. Application Data
(60) Provisional application No. 60/670,365, filed on Apr. 12, 2005.

(51) Int. Cl. G06Q 40/00

(52) U.S. Cl. 705/39; 705/37

(57) ABSTRACT

A system and method for the collection and management of firearm transactions and logs for facilitating firearm transfer processes and maintenance of firearm logs and manifests pursuant to federal, state, and local regulations. The present invention further enables the synchronization, accessibility and transferability of the collected and managed information between firearm vendors and federal, state, and local regulatory agencies for review and management of same.

### PRIORITY CLAIM

To the fullest extent permitted by law, the present nonprovisional patent application claims priority to, and the full benefit of, provisional patent application Ser. No. 60/670,365, entitled “System and Method for the Collection and Management of Firearm Transactions and Logs,” filed on Apr. 12, 2005.

### TECHNICAL FIELD

The present invention relates generally to management systems within the firearm industry, and more specifically to a system and method for the collection and management of firearm transactions and logs, wherein the present system and method facilitates standardization of firearm acquisition and disposition processes and, thus, compliance with federal, state, and local firearm regulations.

### BACKGROUND OF THE INVENTION

Licensed firearm vendors are required to maintain firearm transaction records that fully comply with federal, state, and/or local firearm regulations. Unfortunately, the vast majority of such record-keeping efforts are largely paper-based processes, requiring the use of specific federal forms, and reference to certain literature, for full compliance and accuracy. Indeed, improper or inaccurate records-keeping can subject the firearm vendor to significant fines and potential loss of licensure.

Accordingly, many firearm vendors maintain paper-based records for a minimum of twenty-years, typically storing such records on-site to facilitate retrieval and/or government review processes of same. However, for large firearm vendors, such as WAL-MART, a twenty-year corporate records maintenance policy can be become grossly voluminous and extremely difficult to properly manage.

Additionally, the firearm records-keeping and filing processes for federal and state regulations are largely out-dated, requiring significant expenditure of government personnel resources for the maintenance and management of same; thereby, further frustrating general management of firearm transactions.

Therefore, it is readily apparent that there is a need for a system and method for the collection and management of firearm transactions and logs, wherein the present system and method facilitates the electronic management of general firearm acquisition and disposition records-keeping, firearm monitoring and auditing processes, standardization of firearm acquisition and disposition processes, vendor compliance with federal, state, and local firearm regulations, and access or retrieval of such information by federal, state and/or local regulatory agencies for review of same. There is a further need for such a system and method that will provide a paperless system for simplifying and expediting the firearm transaction management and maintenance process.

### BRIEF SUMMARY OF THE INVENTION

Briefly described, in a preferred embodiment, the present invention overcomes the above-mentioned disadvantages, and meets the recognized need for such an invention by providing a software system and method for the collection and management of firearm transactions and logs for facilitating firearm transfer processes and maintenance of firearm logs and manifests pursuant to federal, state, and local regulations. The present invention further enables the synchronization, accessibility, and transferability of the collected and managed information between firearm vendors and federal, state, and local regulatory agencies for review and management of same.

According to its major aspects and broadly stated, the present invention in its preferred form is a software system and method for the collection and management of firearm transactions and logs, comprising, in general, a process for collecting the requisite information and materials; a process for validating and normalizing the information collected against a set of criteria; a process for reporting and printing the information collected; a process for managing and editing the information collected; a process for maintaining the information collected; a process for transferring and sharing the information collected; a process for archiving the information collected; a process for searching and filtering the information collected; and, a process for exporting and importing the information collected.

More specifically, the present invention is a software system and method for the collection and management of firearm transactions and logs, comprising: a process for collecting information and materials, including all federal, state, and local regulated forms required for the transfer of a firearm between one or more entities including, but not limited to, ATF Form 4473, ATF Form 3310, other required documentation including future revisions, future releases, and newly required forms, proof of residency, proof of citizenship, and proof of eligibility to possess a firearm (i.e., firearm permits, hunting permits, waivers, and other forms of eligible documentation or identification); a process for validating and normalizing the information collected, preferably against federal, state, and local regulations and requirements; a process for reporting and printing the information collected; a process for managing and editing the information collected; a process for maintaining the information collected; a process for transferring and sharing the information, including, but not limited to, via paper or electronic mediums; a process for archiving the information collected, including, but not limited to, via paper or electronic mediums; a process for searching and filtering the information collected; and, a process for exporting and importing the information collected, including, but not limited to, via paper or electronic mediums.

Accordingly, a feature and advantage of the present invention is its ability to provide firearm vendors, government regulatory agencies, and firearm purchasers with an efficient, expeditious and standardized firearm transaction management and maintenance process, including the collection, management, and retrieval, of all materials and information related thereto.

Another feature and advantage of the present invention is its ability to enable PC or thin client installation at the seller's physical retail location to enable both the seller and buyer to interact with the provided software system.

Still another feature and advantage of the present invention is its ability to provide an Internet-enabled customer-kiosk terminal, wherein both the buyer and seller may interact with one another via LCD-type touch-screens, or the like, on which graphical user interfaces are automatically and sequentially displayed in accordance with the code generated by the present transaction application running on the computing platform driving the customer-kiosk terminal.

Yet another feature and advantage of the present invention is its ability to provide a kiosk terminal, wherein behavioral interaction of both the buyer and seller are automatically guided under the scripts driving the interactive kiosk terminal so as to ensure that a predetermined quality of customer services is delivered to the buyer.

Still yet another feature and advantage of the present invention is its ability to provide an Internet-enabled customer-kiosk terminal (i.e., computer subsystem) realized as a micro-computing system running as an operating system, networking software to support the TCP/IP protocol, Internet access software (e.g., web browser software such, as MICROSOFT EXPLORER) to access the world-wide-web and other information resources on the Internet, and peripheral hardware and software components, such as an LCD panel, keyboard, mouse, signature keypad, multi-printer, and thin client connected to a network interface controller card operably connected to a system bus architecture, for enabling data packet communications over a packet-switched information network (e.g., Internet).

These and other features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 illustrates a general transaction process of the present system and method, according to a preferred embodiment of the present invention;

FIG. 2 illustrates a buyer interview process of the present system and method, according to a preferred embodiment of the present invention;

FIG. 3 illustrates a buyer validation process of the present system and method, according to a preferred embodiment of the present invention;

FIG. 4 illustrates a seller interview process of the present system and method, according to a preferred embodiment of the present invention;

FIG. 5 illustrates an NICS Check process of the present system and method, according to a preferred embodiment of the present invention;

FIG. 6 illustrates a seller validation process of the present system and method, according to a preferred embodiment of the present invention;

FIG. 7 illustrates a transaction validation process of the present system and method, according to a preferred embodiment of the present invention;

FIG. 8 illustrates a firearm acquisition process of the present system and method, according to a preferred embodiment of the present invention;

FIG. 9 illustrates a firearm disposition process of the present system and method, according to a preferred embodiment of the present invention;

FIG. 10 illustrates an audit authorization process of the present system and method, according to a preferred embodiment of the present invention;

FIG. 11 illustrates a transferee interview process of the present system and method, according to another embodiment of the present invention;

FIG. 12 illustrates a transferor interview process of the present system and method, according to another embodiment of the present invention;

FIG. 13 illustrates a transaction finalization process of the present system and method, according to another embodiment of the present invention; and,

FIG. 14 illustrates a firearm acquisition and disposition process of the present system and method, according to another embodiment of the present invention.

### DETAILED DESCRIPTION OF THE PREFERRED AND ALTERNATIVE EMBODIMENTS

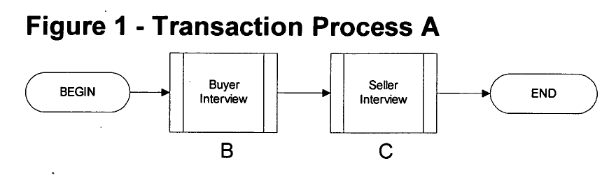

In describing the preferred and alternate embodiments of the present invention, as illustrated in FIGS. 1-14, specific terminology is employed for the sake of clarity. The invention, however, is not intended to be limited to the specific terminology so selected, and it is to be understood that each specific element includes all technical equivalents that operate in a similar manner to accomplish similar functions.

The following disclosure utilizes the below listed terms, on a non-limiting basis, to facilitate description and explanation of the present system and method:
1. Firearm Assistant (FA): the application used to implement the present system and method for the collection and management of firearm transactions and logs.
2. Auditor: any governing body that reviews records for the purpose of tracking and managing a dealer, or multiple dealers. Examples of an auditor include the ATF, WAL-MART Gun Center, SBI (State Bureau of Investigation), and owners of multiple dealerships.
3. Dealer: any entity that holds a Federal Firearm License (FFL) and performs the operations required to transfer a firearm under federal, state, and local regulation. An example of a dealer would be The ABC Gun Shop.
4. Transaction: the process of gathering information from both a buyer and a seller, validating that information, creating the proper documentation to complete the transaction, and recording the process under federal, state, and local regulations.
5. Bound Book: a firearm transaction log used to record and maintain the movement of firearms in and out of a dealer's ownership. The contents and maintenance of a bound book are typically governed by federal code or statute (see, e.g., 27 C.F.R. §178.125).
6. Federal Regulations: any and all regulations provided by the federal government that govern the processing of a firearm transaction. Example: ATF regulations.
7. State Regulations: any and all regulations provided by a seller's or buyer's state that governs the processing of a firearm transaction. Example: SBI regulations.
8. Local Regulations: any and all regulations provided by local governments, or dealership specific, that govern the processing of a firearm transaction. Example: Gwinnett County, Georgia, WAL-MART Gun Center.
9. National Instant Criminal Background Check System (NICS): a national system that checks available records on persons who may be disqualified from receiving firearms.

Referring generally now to FIGS. 1-10, the present invention in a preferred embodiment is a system and method for the collection and management of firearm transactions and logs, comprising firearm transaction process A, buyer interview process B, buyer validation sub-process C, seller interview process D, background check sub-process E, seller validation sub-process F, transaction validation sub-process G, firearm acquisition process H, firearm disposition process I, and, audit authorization process J.

Referring now to FIG. 1, firearm transactions are the basis for the firearm assistant application of the present invention. In order to properly gather, validate, record, and manage the information, forms, and additional media needed to properly complete a firearm transaction between two parties, firearm transaction process A is preferably separated into two major categories: buyer interview process B and seller interview process D. As more fully described hereinbelow, buyer interview process B preferably comprises buyer validation sub-process C, wherein seller interview process D preferably comprises background check sub-process E, seller validation sub-process F, and transaction validation sub-process G.

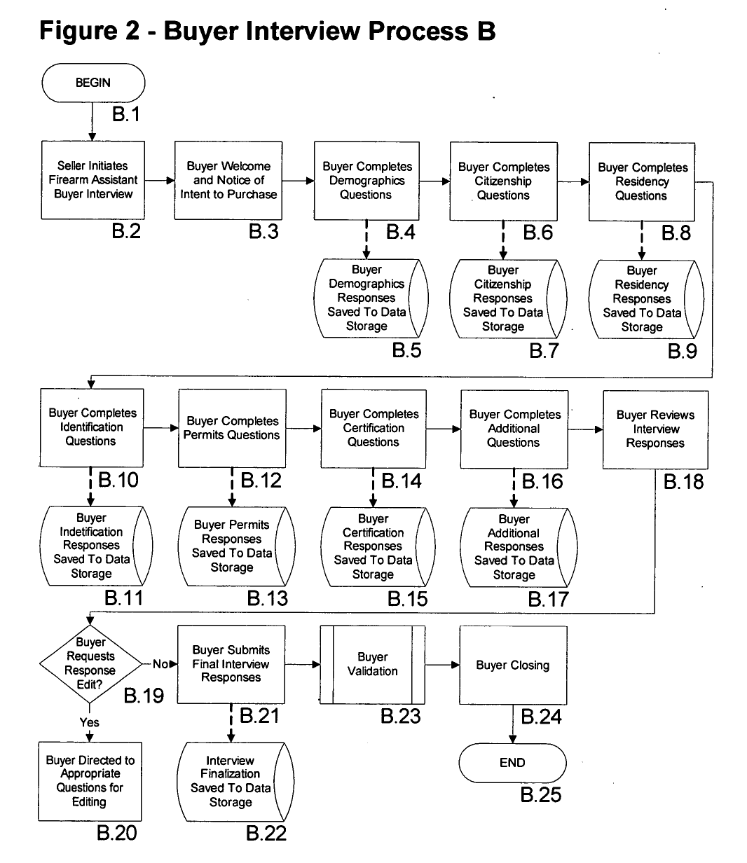

Accordingly, and with reference now to FIG. 2, buyer interview process B is designed to gather information from the intended buyer that will be used to accurately validate the buyer's right to purchase a firearm from the dealer (i.e., seller), complete the necessary forms, and record the required information for a bound book (described more fully hereinbelow). Buyer interview process B is initiated (B.1) by the seller from which the buyer intends to purchase the firearm (B.2). The buyer is then provided an overview of why the buyer is being asked to complete an informational questionnaire and to confirm the buyer's intent to purchase a firearm (B.3). The buyer then completes a series of questions geared toward obtaining the information required to complete the forms and logs needed to complete transaction process A, wherein the questions preferably include, without limitation, demographics questions B.4, citizenship questions B.6, residency questions B.8, identification questions B.10, permits questions B.12, certification questions B.14, and other pertinent questions B.16.

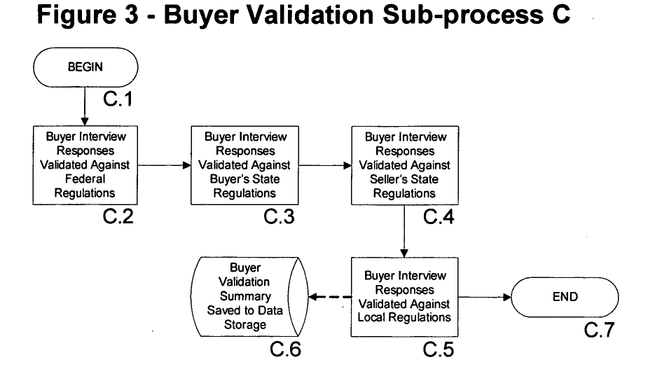

As the buyer proceeds through the questioning process described hereinabove, the buyer's responses to questions B.4 through B.18 are saved or otherwise recorded via respective data storage procedures B.5, B.7, B.9, B.11, B.13, B.15, B.17. After the questionnaire is complete, the buyer is provided a review screen (B.18) that enables the buyer to view his/her responses for accuracy. Should the buyer wish to change a response, such as a misspelling, then the buyer is provided such an opportunity at this time (B.19). If the buyer chooses to make a change, he/she will be guided back to the proper questionnaire section for editing his/her response (B.20). Once the responses provided by the buyer are deemed accurate by the buyer, the final information is submitted (B.21) to buyer validation sub-process C (B.23; see also FIG. 3), and saved via data storage procedure (B.22). Thereafter, the buyer is then provided a closing screen (B.24) and buyer interview process B is completed (B.25).

Referring now more specifically, to FIG. 3, buyer validation sub-process C is required by all transaction processes A to validate the eligibility of a buyer to purchase a firearm. To begin (C.1) buyer validation sub-process C, the buyer's responses submitted during buyer interview process B are validated and normalized against federal (C.2), state (C.3, C.4), and local (C.5) rules and regulations. A buyer validation summary is generated and recorded (C.6) and, as more fully described hereinbelow, subsequently provided or otherwise made accessible for review by the seller during seller interview process D; thus, ending (C.7) buyer validation sub-process C.

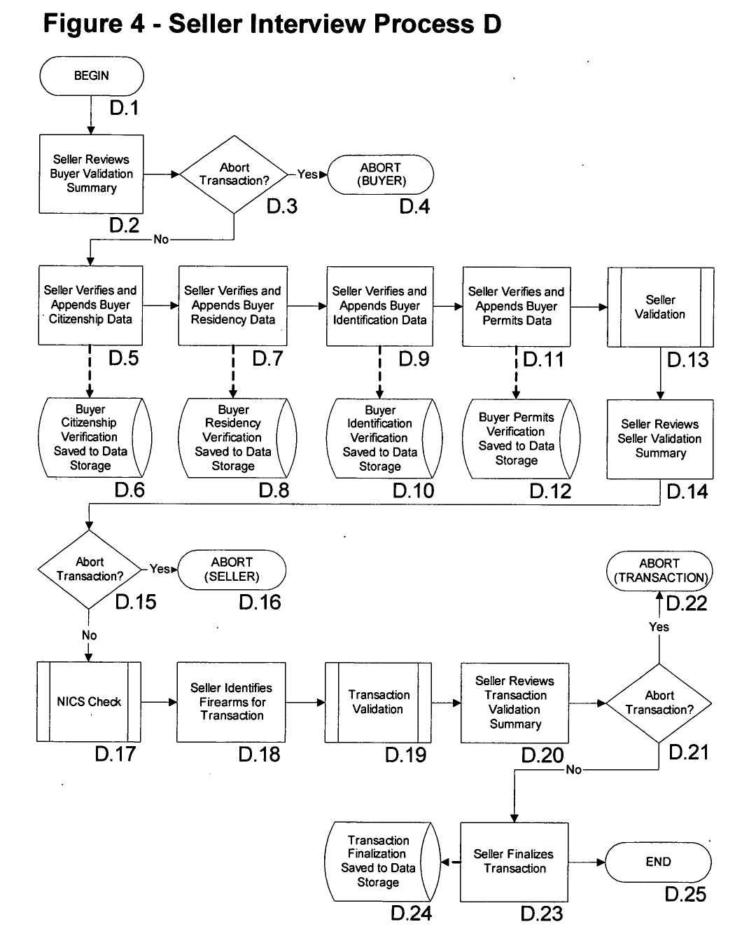

Referring now to FIG. 4, with respect to seller interview process D, after completing buyer interview process B, the buyer's information will be accessible to the seller via an online system (i.e., such as, for exemplary purposes only, a designated website). Accordingly, to begin (D.1) seller interview process D, and as an initial step to validating the buyer's eligibility to purchase a firearm, the buyer validation summary generated during buyer validation sub-process C will be provided to the seller for his/her review (D.2).

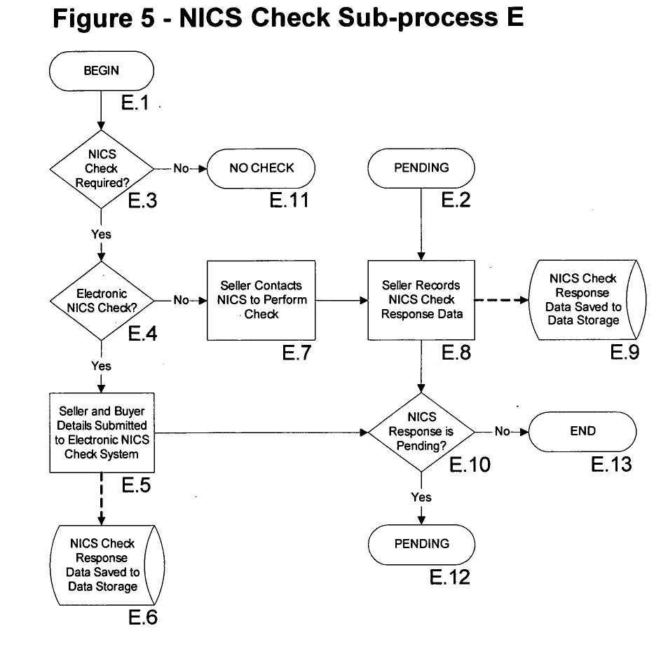

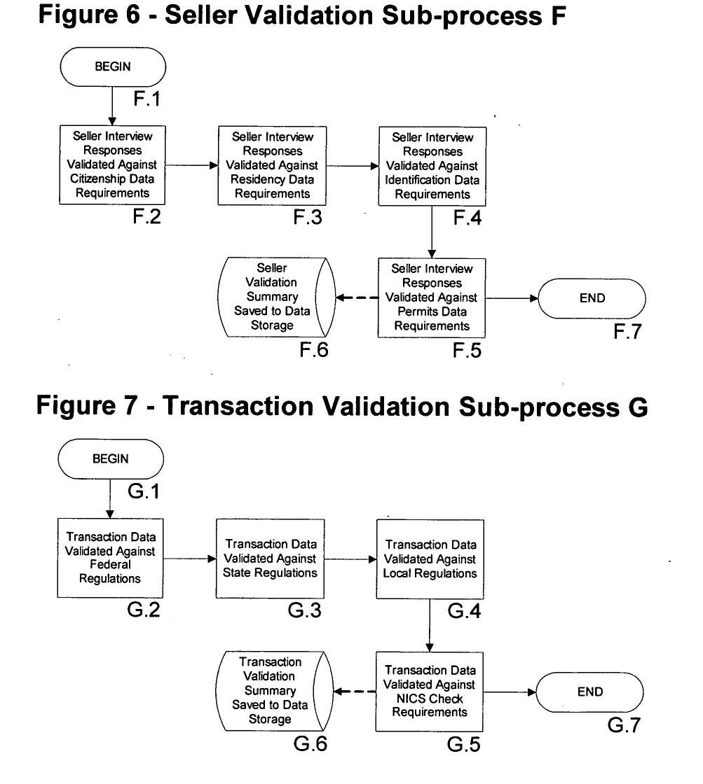

The seller'will then be guided (D.3) to either abort (D. 4) transaction process A, or, if the seller wishes to continue, and assuming buyer validation sub-process C has been appropriately completed, the seller will be asked to verify the information collected during the questionnaire of buyer interview process B, and to also append any documentation required to validate the buyer's response. As such, the seller will be asked to verify and append buyer citizenship data (D.5), verify and append buyer residency data (D.7), verify and append buyer identification data (D.9), and verify and append buyer permits data (D.11). Following each step D.5 through D.11, the seller's responses will be recorded via respective data storage procedures D.6, D.8, D.10, D.12. Once complete with verification steps D.5 through D.11, the seller's responses and additions are validated and normalized against federal, state, and local regulations (D.13) via seller validation sub-process F (see FIG. 6). The seller is then provided a seller validation summary (D.14) where the seller is given the opportunity (D.15) to abort (D.16) transaction process A based on the validation summary recommendations. Should the seller wish to continue transaction process A, then both the buyer's responses to the buyer interview process B, and the seller's responses to seller interview validation steps D.5 through D.11, are submitted to an NICS Check (D.17) via background check sub-process E (see FIG. 5). Once provided with an approval from the NICS, the seller will then identify, from a bound book, the firearms that the buyer intends to purchase (D.18). After selecting the firearms, the seller's responses, buyer's responses, and the selected firearms are validated one more times via transaction validation process G (D.19; see also FIG. 7). The seller is then provided a validation summary for review. (D.20) and provided an opportunity (D.21) to abort (D.22) transaction process A. Should the seller continue with transaction process A, the seller will then finalize the firearm transaction (D.23) and makes any final entries required to complete transaction process A. This information is saved (D.24) and transaction process A is complete (D.25).

Referring now to FIG. 5, NICS or background check sub-process E is designed around the current and future processes of performing a federal and/or state background check. There are some licenses that provide background check exemption. Background check sub-process E begins (E.1) with an evaluation of the buyer's responses to buyer interview process B and the seller's responses to seller interview process D, for a determination of whether or not a NICS Check is required (E.3). If no check is required, sub-process E is terminated. After determining the need for a NICS Check, sub-process E then determines the method, electronic or phone, required to perform the check (E.4) With an electronic check, the information required by the NICS is sent via an NICS electronic system (E.5) and the response is recorded (E.6) via an associated data storage procedure. For phone checks, the seller is provided the required details and prompted to contact the appropriate NICS center (E.7). Upon completing the check, the user is required to enter initial NICS Check response data (E.8), wherein the details of same are saved (E.9) via an associated data storage procedure. Sub-process E then validates the NICS response and responds accordingly (E.10). If the response from the NICS check is ‘pending’, sub-process E flags the transaction as pending and awaits a response from NICS to complete transaction process A (E.12). For transactions previously flagged as ‘pending’, the seller is returned to this process through the “Begin: Pending object” (E.2). Once the response is considered a closed response, either ‘approved’ or ‘denied’, sub-process E is marked completed and terminates for this transaction (E.13).

Referring now to FIG. 6, seller validation sub-process F is performed as a feature of all transaction processes A after the seller has validated the information provided by the buyer during buyer interview process B. To begin (F.1) sub-process F, the buyer's and seller's responses are validated against data requirements for citizenship (F.2), residency (F.3), identification (F.4), and permits (F.5) Once validated, a validation summary is saved (F.6) and is provided for review during seller interview process D; thus, terminating (F.7) sub-process F.

Referring now to FIG. 7, transaction validation sub-process G takes into account all information gathered during transaction process A. To begin (G.1) sub-process G, the buyer's responses, seller's responses, and selected firearms are validated and normalized against federal (G.2), state (G.3), and local (G.4) regulations. Additionally, a final NICS check validation (G.5) is performed to verify the response, or responses, provided by the NICS. A validation summary is recorded to the system (G.6) and sub-process G terminates (G.7).

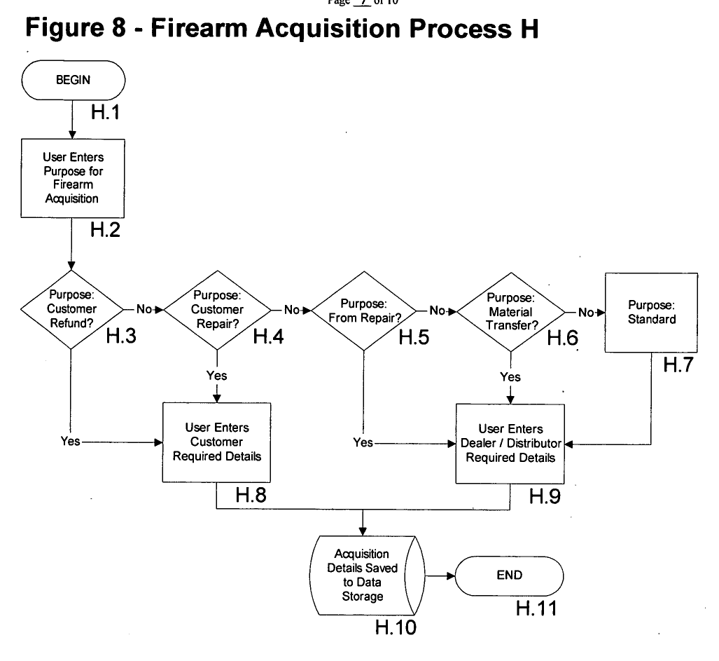

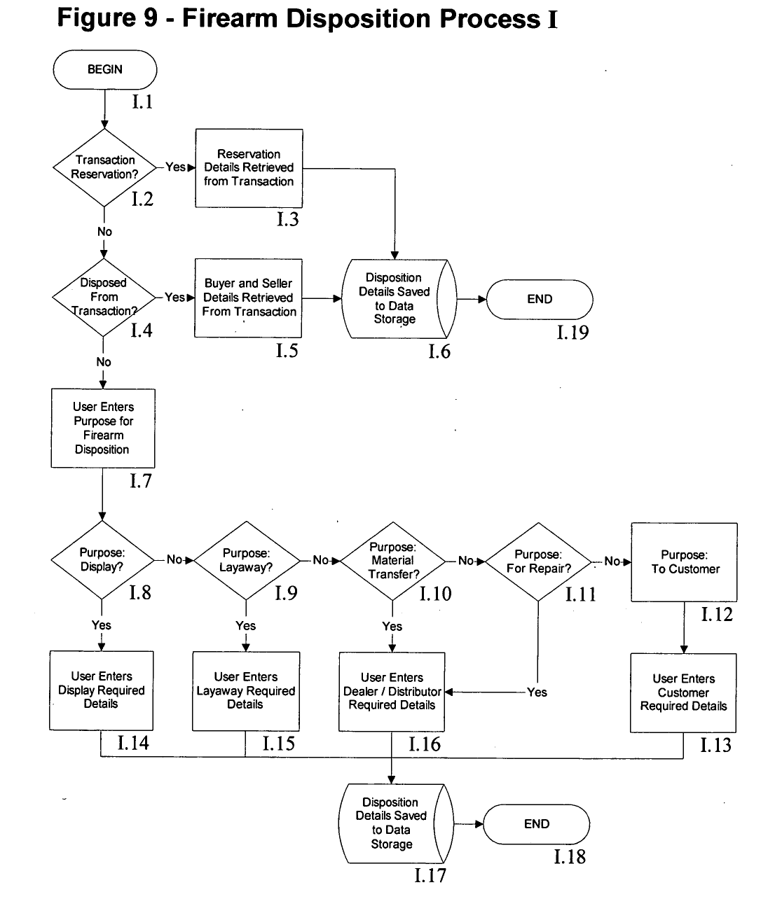

With reference now to the issue of a bound book, such is used to maintain transaction details as well as the inflow and outflow of firearms through a dealer, as may be required under federal, state and/or local law. The bound book has two major activities: firearm acquisition process H (see FIG. 8) and firearm disposition process I (see FIG. 9). In the firearm assistant application of the present invention, the bound book is preferably managed electronically and integrated with transaction process A. However, the firearm assistant application of the present invention alternatively provides the same firearm acquisition and disposition functionality and processes as herein described, although not dependent upon, and otherwise integrated and automated by, transaction process A.

As such, and referring now to FIG. 8, firearm acquisition process H is utilized to log the information required to accurately record the transfer of a firearm into the dealer's ownership. To begin (H.1) firearm acquisition process H, the dealer/seller is prompted to provide the purpose for the acquisition of the firearm (H.2). The purposes for acquisition preferably include, without limitation, customer refund purposes H.3, customer repair purposes H.4, acquisition from a repair H.5, material transfer purposes H.6, or other standard purposes H.7. Depending on the purpose of the acquisition (H.3-H.7) the dealer will be prompted to provide either customer (H.8) or dealer (H.9) specific details stating from whom the firearm was acquired. This information is recorded (H.10) and firearm acquisition process H terminates (H.11).

Referring now to FIG. 9, firearm disposition process I is required to log the information required to accurately record the transfer of a firearm out of the dealer's ownership. To begin (I.1), disposition process I first determines whether or not the disposition is a reservation of a firearm for a currently pending transaction (I.2). If in fact a reservation, the required reservation details are gathered from the pending transaction (I.3) and the details are saved (I.6) via an associated data storage procedure. If not a reservation, disposition process I then determines if the disposition is initiated by a transaction or the dealer (I.4). If the disposition is from a transaction, the required-buyer and seller details are gathered from the transaction (I.5) and recorded (I.6) via an associated data storage procedure. If a dealer initiated disposition, the dealer is asked to provide the purpose for the firearm disposition (1.7), wherein the purpose for firearm disposition preferably includes, without limitation, display purposes I.8, layaway purposes I.9, material transfer purposes I.10, for repair purposes I.11, or for disposition to the customer I.12. Depending upon the purpose of the disposition (I.8-I.12), display (I.14), layaway (I.15), dealer (I.16), or customer (I.13), details are entered by the dealer and recorded (I.17) via an associated data storage procedure. Disposition process I is thereafter terminated (I.18).

With reference now to the auditing portal feature of the present invention, such will provide an auditor with the tools and functionality required to properly manage, search, report on, and maintain groups of dealers for which the auditors have authorization to audit. With proper authorization, an auditor can view large groups of information from multiple dealers to view trends, find records, and report on these results. The auditing portal is designed to decrease the time required for governing bodies (federal, state, and local) to review information obtained by dealers through the transaction and bound book processes.

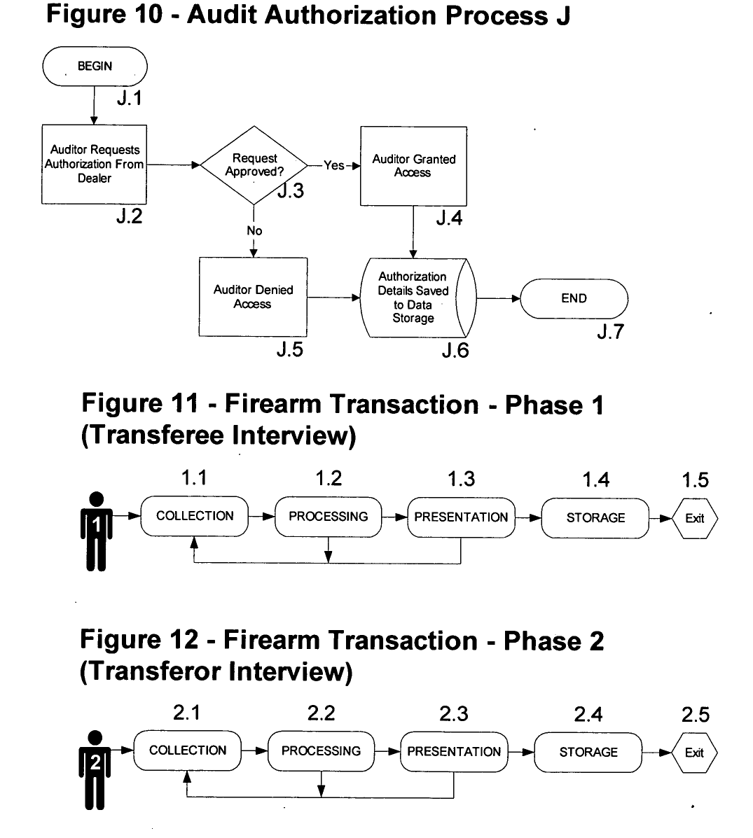

As such, and referring now to FIG. 10, audit authorization process J is used by an auditor to request authorization to view a dealer's records. To begin (J.1), the auditor first requests permission from the dealer (J.2). Upon receiving the request, the dealer is provided the opportunity to approve or deny the auditor authorization (J.3). If the dealer grants authorization, the auditor is notified of the approval (J.4) and the approval status is recorded (J.6), making the dealer's records available. If the dealer denies authorization, the auditor is still notified of the denial (J.5), the denied status is recorded (J.6); and, the auditor does not receive authorization to view the dealer's records.

Referring now more specifically to FIGS. 11-14, illustrated therein is an alternate and simplified representation of the present system and method. Specifically, firearm transaction process A of present system may be defined to include three phases: buyer or transferee interview phase 1, which represents the combined steps of collecting (1.1), processing (1.2), presenting (1.3), and storing (1.4) data provided by a prospective firearm buyer; seller or transferor interview phase 2, which represents the combined steps of collecting (2.1), processing (2.2), presenting (2.3), and storing (2.4) data provided by a firearm seller; and, transaction finalization phase 3, which provides a merger between the buyer (transferee) and seller (transferor) to facilitate and log a firearm transaction process and, thus, represents the combined steps of presenting (3.1), collecting (3.2), processing (3.3), and storing (3.4) data provided by phase 1 and phase 2. Each of the foregoing phases and associated steps/processes is described in further detail hereinbelow.

With specific reference now to FIG. 11, transferee interview phase 1 comprises the steps of collecting 1.1, processing 1.2, presenting 1.3, and storing 1.4 data provided by a prospective firearm transferee. During collection step 1.1, the transferee is asked to provide data required to begin a firearm transaction under federal, state, and local regulations. This data is processed during processing step 1.2, and either forwarded to presentation step 1.3 if all requirements are met, or returned to collection step 1.1 in an attempt to collect the additional data required. During presentation step 1.3, the transferee is presented with the details of his request and asked to verify the data he provided. If the transferee agrees with the representation of his data, that data is stored and the transferee exits (1.5) phase 1. If the transferee has a discrepancy with the data represented, he is provided with the ability to return to collection step 1.1 and correct any inaccuracies, prior to exiting (1.5) phase 1.

With specific reference now to FIG. 12, transferor interview phase 2 similarly comprises the steps of collecting 2.1, processing 2.2, presenting 2.3, and storing 2.4 data provided by a firearm transferor. During collection step 2.1, the transferor is asked to provide the data required to begin/continue a firearm transaction under federal, state, and local regulations. This data is processed during processing step 2.2, and either forwarded to presentation step 2.3 if all requirements are met, or returned to collection step 2.1 in an attempt to collect the additional data required. During presentation step 2.3, the transferor is presented with the details of his data and asked to verify the data he provided. If the transferor agrees with the representation of his data, that data is stored and the transferor exits (2.5) phase 2. If the transferor has a discrepancy with the data represented, he is provided with the ability to return to the collection step 2.1 and correct any inaccuracies, prior to exiting (2.5) phase 2.

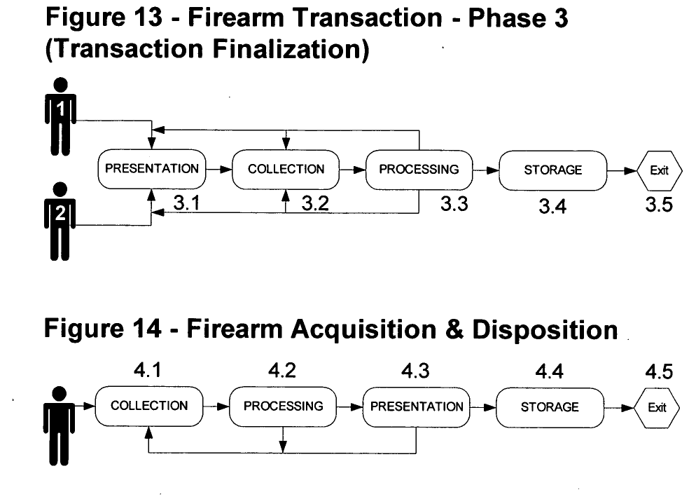

With specific reference now to FIG. 13, transaction finalization phase 3 provides a merger between the transferee and transferor to facilitate and log a firearm transaction process and, thus, provides the steps of presenting (3.1), collecting (3.2), processing (3.3), and storing (3.4) data provided by, or otherwise generated via, phase 1 and phase 2. That is, during presentation step 3.1, the transferee and transferor are provided with the details of the data gathered and generated during phase 1 and phase 2 for final review and authorization. The authorization to finalize the transaction is collected during collection step 3.2, along with any additional data required to complete the transaction under federal, state, and local regulations. The data is then passed to processing step 3.3. If processing step 3.3 determines that all data requirements have not been met, then transferee and/or transferor may be redirected back to collection step 3.2 in an attempt to gather the required data. Processing step 3.3 may further determine that the transferee and/or transferor may need to reconfirm the authorization, or details, of the transaction and, thus, redirect the transferee and/or transferor back to presentation step 3.1. If all data requirements have been met, however, processing step 3.3 will move the data to storage step 3.4, and thereafter exit (3.5) phase 3.

Upon completion of phases 1-3, as described hereinabove, both the transferee and transferor will have provided the data required to either complete, or nullify, the requirements to transfer a firearm between the two entities, as directed under federal, state, and local regulations.

Referring now more specifically to FIG. 14, in furtherance of providing a simplified representation of the present system and method as illustrated in FIGS. 11-13, phase 1-3 described hereinabove may be further described in association with firearm acquisition and disposition process 4, which enables the user to log the acquisition and disposition of firearms under federal, state, and local regulations. Similar to phases 1-3, acquisition and disposition process 4 may be characterized by data collection step 4.1, data processing step 4.2, data presentation step 4.3, and data storage step 4.4. Specifically, during collection step 4.1, the user is asked to provide the data required to log the acquisition or disposition of a firearm under federal, state, and local regulations. This data is passed to processing step 4.2, and either forwarded to presentation step 4.3 if all requirements are met, or returned to collection step 4.1 in an attempt to collect the additional data required. During presentation step 4.3, the transferor is presented with the details of his data and asked to verify the data he provided. If the transferor agrees with the representation of his data, that data is stored and the transferor exits (4.5) process 4. If the transferor has a discrepancy with the data represented, he is provided with the ability to return to collection step 4.1 and correct any inaccuracies, prior to exiting (4.5) process 4.

Upon completing firearm acquisition and disposition process 4, the user will have successfully logged the acquisition, disposition, and/or alteration of a firearm, as required under federal, state, and local regulations.

It should be recognized that the data collection activity provided by the various steps and/or processes of the present invention, such as, for exemplary purposes only, buyer interview process B, seller interview process D, phases 1-3, and/or process 4, may be implemented via any suitable method and/or device, including, without limitation, software, hardware, document scanning technology, optical character recognition (OCR) technology, web services, data imports, Internet browsers, software applications, digital signature pads, scanners, biometric devices (i.e., fingerprint recorders, retinal scanners, etc.), and the like.

Additionally, it is contemplated that the data storage and/or recordation procedures provided in the various steps and/or processes of the present invention maybe accomplished via magnetic devices (i.e., hard drives, card strips, etc.), optical devices (i.e., CD-ROM, DVD, etc.), memory devices (USB “thumb” drive, virtual memory, RAM, etc.), paper or printed methods, and the like.

As addressed hereinabove, the data presentation activity provided by the various steps and/or processes and/or sub-processes of the present invention is preferably manifested in the form of completed federal (ATF Form 4473/3310), state, and local forms and documents; firearm transaction log records and books (i.e., the bound book); and/or dynamic reports representing data provided by the various data storage, data collection, and/or data processing features described hereinabove. Accordingly, the present invention contemplates that such data presentation may be provided via standardized data files (i.e., comma delimited files, XML files, PDF files, etc.), visual representation (i.e., LCD, plasma, or CRT monitors, and software or browsers); and/or physical representations (i.e., printed documents and reports).

Having thus described exemplary embodiments of the present invention, it should be noted by those skilled in the art that the within disclosures are exemplary only, and that various other alternatives, adaptations, and modifications may be made within the scope of the present invention. Additionally, merely listing or numbering the steps of a method in a certain order does not constitute any limitation on the order of the steps of that method. Accordingly, the present invention is not limited to the specific embodiments illustrated herein, but is limited only by the following claims.

What is claimed is:

1. A system for the collection and management of firearm transactions and logs, comprising:
a process for collecting information, including at least one of federal, state, and local regulated forms, as may be required for the transfer of a firearm between one or more persons or entities, as buyer and seller;
a process for validating and normalizing said collected information against at least one corresponding federal, state, and local regulation or requirement;
a process for reporting and printing said collected information;
a process for managing and editing said collected information;
a process for maintaining said collected information;
a process for transferring and sharing said collected information;
a process for archiving said collected information;
a process for searching and filtering said collected information; and,
a process for exporting and importing said collected information.

2. The system of claim 1, wherein said process for collecting information further comprises the collection of one or more pieces of information selected from the group consisting of ATF forms, proof of identity, proof of residency, proof of citizenship, proof of eligibility to possess a firearm, demographics information, permit information, and certification information.

3. The system of claim 2, wherein the buyer is provided a review screen enabling the buyer to review his/her response for accuracy; to edit the response in a system-guided manner; and, to finalize the information when accurate.

4. The system of claim 2, wherein the buyer's response to said process of collecting information is saved or otherwise recorded.

5. The system of claim 1, wherein said process for validating and normalizing said collected information includes the generation of a buyer validation summary.

6. The system of claim 5, wherein said buyer validation summary is made accessible for review by the seller.

7. The system of claim 6, wherein the seller is guided by said system to conditionally abort the transaction.

8. The system of claim 6, wherein the seller is guided by said system to conditionally continue the transaction, to verify said collected information, and to append such additional documentary information as may be required to conclude the transaction.

9. The system of claim 8, wherein the seller's responses to said guided system are recorded and stored.

10. The system of claim 6, wherein said process for validating and normalizing said collected information includes the generation of a seller validation summary.

11. The system of claim 8, wherein said process for validating and normalizing said collected information includes submittal of at least a portion of said collected information to the National Instant Criminal Background Check System.

12. The system of claim 11, wherein, conditioned upon approval from the National Instant Criminal Background Check System, the seller identifies, from a bound book, the firearms that the buyer intends to purchase.

13. The system of claim 12, wherein the seller's responses, buyer's responses, and the identified firearms are further validated at least one time.

14. The system of claim 13, wherein the seller is provided a validation summary for review.

15. The system of claim 14, wherein the seller is provided a guided opportunity to abort the transaction.

16. The system of claim 14, wherein the seller is guided to finalize the firearm transaction and to make final entries required to complete the transaction.

17. The system of claim 14, wherein at least one transaction record is saved.

18. The system of claim 11, wherein the information required by the National Instant Criminal Background Check System is sent via a National Instant Criminal Background Check System electronic system and a response therefrom is recorded via an associated data storage procedure.

19. The system of claim 11, wherein the seller is prompted to contact a National Instant Criminal Background Check System center.

20. The system of claim 1, further comprising a guided firearm acquisition process for logging, according to an acquisition purpose, such information as required to accurately record the transfer of a firearm into the seller's ownership.

21. The system of claim 20, wherein said acquisition purpose is selected from the group consisting of a customer refund purpose, a customer repair purpose, an acquisition from repair purpose, a material transfer purpose, and another user defined purpose.

22. The system of claim 1, further comprising a guided firearm disposition process for logging, according to a disposition purpose, such information as required to accurately record the transfer of a firearm out of the seller's ownership.

23. The system of claim 22, wherein said disposition purpose is selected from the group consisting of a display purpose, a layaway purpose, a material transfer purpose, a repair purpose, and another user-defined purpose.

24. The system of claim 1, wherein said process for transferring and sharing said collected information comprises a guided audit authorization process enabling a third party to gain authorization, on a seller approved conditional basis, to view a seller's transaction record.

25. The system of claim 1, wherein at least one of said processes further comprise a paper medium.

26. The system of claim 1, wherein at least one of said processes further comprise an electronic medium.

27. The system of claim 1, wherein the transferees, as buyer and seller, interact with said system at the seller's physical retail location.

28. The system of claim 1, further comprising an electronic network-enabled customer-kiosk terminal.

29. The system of claim 28, wherein the transferees, as buyer and seller, may interact with one another via touch-sensitive screens on which a graphical user interface is automatically and sequentially displayed in accordance with code generated by said system.

30. The system of claim 29, wherein behavioral interaction of the transferees, as buyer and seller, are guided by scripts driving said kiosk terminal.

31. A system for the collection and management of firearm transactions and logs, comprising:
a buyer or transferee interview phase;
a seller or transferor interview phase; and,
a transaction finalization phase.

32. The system of claim 3i, wherein said buyer or transferee interview phase further comprises collecting, processing, presenting, and storing data provided by a prospective firearm buyer.

33. The system of claim 31, wherein said seller or transferor interview phase further comprises collecting, processing, presenting, and storing data provided by a firearm seller.

34. The system of claim 31, wherein said transaction finalization phase further comprises merging the data provided by the buyer and seller to facilitate and log a firearm transaction process.

35. The system of claim 34, wherein said merging of data further comprises presenting, collecting, processing, and storing data provided by said buyer or transferee interview phase and said seller or transferor interview phase.

36. The system of claim 31, wherein the data required conditionally to complete or nullify the transfer of a firearm between a buyer and a seller, is presented, collected, processed, stored, and reported in compliance with one or more of federal, state, and local laws and regulations.

37. A system for the collecting, managing, and logging firearm purchase and sale transactions, comprising:
an acquisition and disposition process comprising a data collection step, a data processing step, a data presentation step, and a data storage step;
said collection step guiding a user to provide data required to log an acquisition or disposition of a firearm under one or more of federal, state, and local regulations;
whereupon the data is passed to said data processing step for further processing;
whereupon the data is conditionally forwarded to said presentation step if all processing requirements are met, or returned to said collection step in an attempt to collect from the user such additional data as may be required; said presentation step presenting the user with the details of the user's data and guiding the user to verify the data provided;
whereupon, if the user agrees with the representation of the user's data, said data is stored and the user exits said process, or the user is guided to return to said collection step to correct any inaccuracies before exiting said process.

38. A system for the collection and management of firearm transactions and logs, said system comprising:
a buyer interview process;
a buyer validation process;
a seller interview process;
a background check process;
a seller validation process;
a transaction validation process;
a firearm acquisition process;
a firearm disposition process; and,
an audit authorization process.
